(19) United States
(12) Patent Application Publication
(10) Pub. No.: US 2015/0161371 A1
(43) Pub. Date: Jun. 11, 2015

(54) ELECTRONIC DEVICE AND AUTHENTICATION CONTROL METHOD

(71) Applicant: KABUSHIKI KAISHA TOSHIBA, Tokyo (JP)

(72) Inventors: Hideo Hoshi, Fuchu Tokyo (JP); Takashi Kitajima, Funabashi Chiba (JP)

(21) Appl. No.: 14/613,713

(22) Filed: Feb. 4, 2015

Related U.S. Application Data
(63) Continuation of application No. PCT/JP2013/057700, filed on Mar. 18, 2013.

(51) Int. Cl. G06F 21/32; G06F 21/44; G06F 21/35

(52) U.S. Cl. CPC G06F 21/32; G06F 21/35; G06F 21/44

(57) ABSTRACT

According to one embodiment, an electronic device includes a first authentication controller, a second authentication controller and a controller. The first authentication controller performs biometric authentication to measure biological data of a user and to determine whether or not the biological data corresponds to registered biological data. The second authentication controller performs inter-device authentication by means of communication between the electronic device and a first external device. The controller enables a predetermined function when the biometric authentication and the inter-device authentication have succeeded.

### CROSS REFERENCE TO RELATED APPLICATIONS

This application is a Continuation Application of PCT Application No. PCT/JP2013/057700, filed Mar. 18, 2013, the entire contents of which are incorporated herein by reference.

### FIELD

Embodiments described herein relate generally to an electronic device and an authentication control method applied to the electronic device.

### BACKGROUND

Recently, various electronic devices such as smartphones and tablet computers have been developed. Most of these kinds of electronic devices have various authentication control functions for authenticating users. As typical authentication control functions, security lock mechanisms using a PIN entry, a pattern entry, and the like are known. When an electronic device is in a state of being locked by a security lock mechanism, only limited functions such as a clock and the like are enabled and most of other functions cannot be used. Therefore, an authentication control function such as a security lock mechanism is useful for ensuring the security of an electronic device.

However, most of conventional security lock mechanisms require the user to perform an entry operation to release their security lock. Therefore, the user needs to perform an entry operation to release the security lock such as, for example, an entry of a PIN registered in advance, an entry of a pattern registered in advance, or the like as described above.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary view illustrating a usage example of an electronic device of the first embodiment.

FIG. 2 is an exemplary schematic diagram showing user authentication processing executed by the electronic device of the first embodiment.

FIG. 3 is an exemplary view of a system structure of the electronic device of the first embodiment.

FIG. 4 is an exemplary block diagram for explaining the user authentication processing executed by the electronic device of the first embodiment.

FIG. 5 is an exemplary flowchart showing a procedure of the user authentication processing executed by the electronic device of the first embodiment.

FIG. 6 is an exemplary view of a database stored in an external device associated with the electronic device of the first embodiment.

FIG. 7 is an exemplary view of a system structure of an electronic device of the second embodiment.

FIG. 8 is an exemplary block diagram for explaining user authentication processing executed by the electronic device of the second embodiment.

FIG. 9 is an exemplary flowchart showing a procedure of the user authentication processing executed by the electronic device of the second embodiment.

### DETAILED DESCRIPTION

Various embodiments will be described hereinafter with reference to the accompanying drawings.

In general, according to one embodiment, an electronic device comprises a first authentication controller, a second authentication controller and a controller. The first authentication controller is configured to perform biometric authentication to measure biological data of the user and to determine whether or not the biological data corresponds to registered biological data. The second authentication controller is configured to perform inter-device authentication by means of communication between the electronic device and a first external device. The controller is configured to enable a predetermined function when the biometric authentication and the inter-device authentication have succeeded.

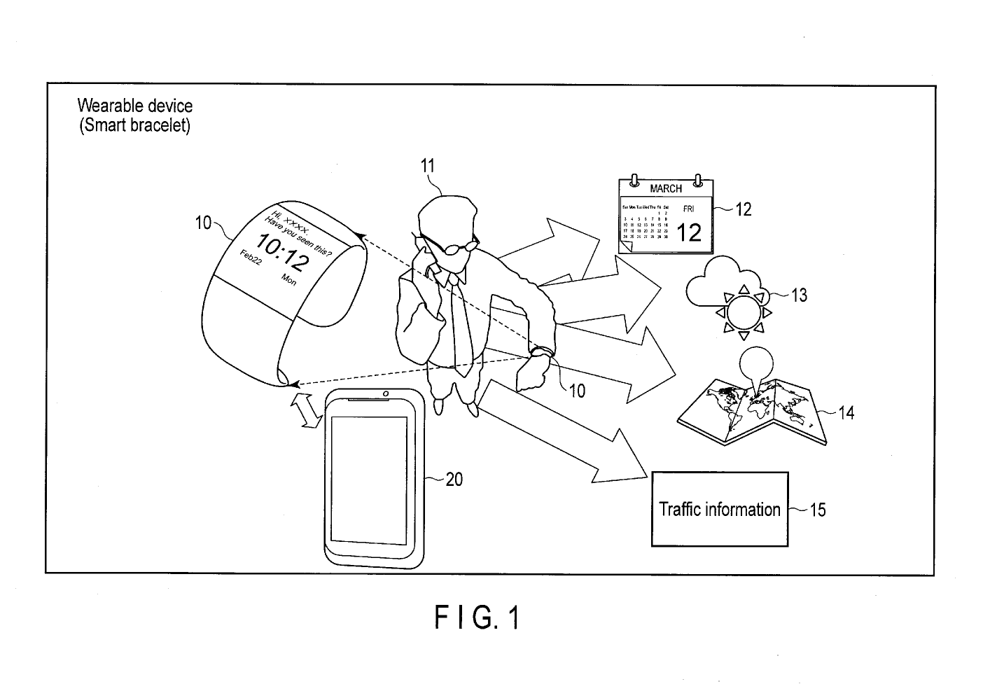

An electronic device of the first embodiment will be briefly described with reference FIG. 1.

The electronic device is a wearable electronic device that can be worn on the human body. The following descriptions assume that this electronic device is realized as a wristwatch-like device 10 which can be worn on the wrist. Hereinafter, the wristwatch-like device 10 will be referred to as an electronic bracelet.

An electronic bracelet 10 is a small device which can be worn on the wrist of a user 11. The electronic bracelet 10 comprises a sensor configured to measure various kinds of biological data of the human body on which the electronic bracelet 10 is worn, such as bioelectrical impedance, heart rate, blood pressure, and the like. Further, the electronic bracelet 10 comprises a wireless communication function. By performing wireless communication with an external device, the electronic bracelet 10 can provide to the user a predetermined function (service) in cooperation with the external device. The external device is a wireless device (mobile communication device) such as a smartphone 20. In the present embodiment, the following descriptions assume that the external device is the smartphone 20. In the present embodiment, the electronic bracelet 10 functions as an auxiliary device of a wireless device, namely, the smartphone 20.

The predetermined function is a function of providing the owner of the electronic bracelet 10 (the user 11 in here) with various kinds of information related to the owner. The information related to the user 11 includes, for example, schedule information 12, weather information 13, location information 14, traffic information 15, or the like. The schedule information 12 is the schedule information of the user 11. The schedule information 12 may be, for example, information of today's schedule of the user 11. The schedule information 12 may be stored in the smartphone 20 or may be stored in a cloud server on the Internet.

In a case where the schedule information 12 is stored in the smartphone 20, the electronic bracelet 10 can acquire the schedule information 12 from the smartphone 20. In a case where the schedule information 12 is stored in the cloud server, the smartphone 20 may receive schedule information from the cloud server in response to a request of schedule information from the electronic bracelet 10.

In both cases, the electronic bracelet 10 can receive the schedule information 12 from the smartphone 20 and display the schedule information 12 on the display of the electronic bracelet 10. The user can check the user's own schedule simply by viewing the display of the electronic bracelet 10 which the user is wearing without operating the smartphone 20.

The weather information 13 is weather information of a predetermined place specified by the user in advance. The weather information 13 is the information of the weather in a region corresponding to the user's home address or of the weather in a region corresponding to the user's office address. The location information 14 is information showing the current location of the smartphone 20 or the electronic bracelet 10. The location information 14 may be, for example, information showing the current location of the user 11 when the user 11 is out and on the road. The traffic information 15 is information related to transportation. The traffic information 15 is information of the timetable of transportation the user 11 frequently uses such as a train, a bus, a plane or the like, the fare of such transportation, or the like.

The electronic bracelet 10 can request the smartphone 20 to acquire the weather information 13, the location information 14, the traffic information 15 or the like. The smartphone 20 accesses various sites on the Internet based on the request from the electronic bracelet 10. The smartphone 20 then receives information such as the weather information 13, the location information 14, the traffic information 15 or the like from various sites. The electronic bracelet 10 can receive information such as the weather information 13, the location information 14, the traffic information 15 or the like from the smartphone 20, and displays the information on the display of the electronic bracelet 10.

Further, the electronic bracelet 10 can also provide the user with information related to the user 11 other than the above-described information. The information related to the user 11 other than the above-described information includes, for example, information of a current time, a date, a day of a week, a message: “Have you seen this?”, or the like. Still further, the electronic bracelet 10 may comprise a GPS function.

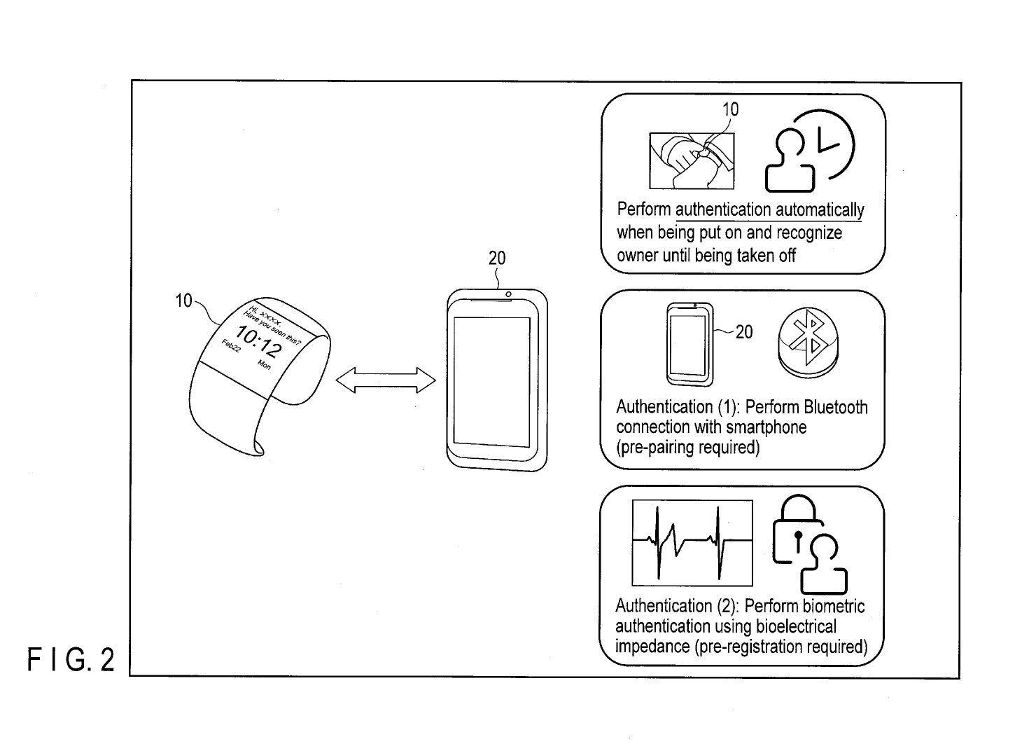

Next, with reference to FIG. 2, authentication processing executed by the electronic bracelet 10 will be briefly described.

As described above, information presented to the user 11 by a predetermined function is information related to the user 11 himself/herself. Therefore, when providing a predetermined function to the user 11, the electronic bracelet 10 performs user authentication processing to determine weather or not the user currently wearing the electronic bracelet 10 is the owner of the electronic bracelet 10. When the user authentication processing has succeeded, that is, when it has been verified that the user currently wearing the electronic bracelet 10 is the owner of the electronic bracelet 10, the electronic bracelet 10 enables the predetermined function. That is, the electronic bracelet 10 comprises a security lock mechanism, and automatically executes the user authentication processing when the electronic bracelet 10 is put on the human body. When the user authentication processing succeeds, the electronic bracelet 10 releases (unlocks) the security lock of the electronic bracelet 10 and enables a predetermined function. Unless the user authentication processing succeeds, the security lock of the electronic bracelet 10 will not be released.

The verification of the user 11 is performed in two-stage authentication of inter-device authentication (authentication 1 of FIG. 2) and biometric authentication (authentication 2 of FIG. 2).

The inter-device authentication is authentication to determine whether or not a wireless connection is established between the electronic bracelet 10 and a predetermined external device associated with this electronic bracelet 10 in advance. The predetermined external device is, for example, a wireless device which the owner of the electronic bracelet 10 carries with him/her at all times. Normally, any wireless device the owner of the electronic bracelet 10 possesses (here, the smartphone 20) may be used as the above-described external device. In the inter-device authentication, the electronic bracelet 10 determines whether or not a wireless device in a range of the wireless communication of the electronic bracelet 10 is a wireless device which has been registered in the electronic bracelet 10 in advance (here, the smartphone 20). A wireless device registered in the electronic bracelet 10 in advance is a wireless device which has already been associated with the electronic bracelet 10. When it is determined that the authentication between the electronic bracelet 10 and a predetermined external device associated with the electronic bracelet 10 in advance (here, the smartphone 20) has succeeded, wireless connection between the electronic bracelet 10 and the smartphone 20 is thereby established.

The processing to associate devices with each other is called pairing. The wireless communication standard used for establishing wireless communication between the electronic bracelet 10 and the smartphone 20 may be any wireless communication standard in which the pairing can be performed between devices such as Bluetooth (registered trademark), Near Field Communication (NFC), ZigBee (registered trademark) or the like. The user 11 needs to perform the pairing in advance to associate the smartphone 20 with the electronic bracelet 10.

As described above, the electronic bracelet 10 comprises a sensor configured to measure biological data (vital data) of the human body such as bioelectrical impedance, heart rate, blood pressure, and the like. The electronic bracelet 10 performs the biometric authentication to determine whether or not the biological data measured by the sensor matches (corresponds to/congruent with/coincides with) biological data registered in the electronic bracelet 10 in advance (registered biological data).

In the biometric authentication, for example, a bioelectrical impedance method may be used. The bioelectrical impedance method is a bioelectrical impedance acquisition method of measuring the bioelectrical impedance between a pair of electrodes provided in a portion of the device which is in contact with a predetermined part of the body (wrist or the like) of the user 11. When the acquired impedance data substantially coincides with the registered impedance data of the user, the electronic bracelet 10 determines this as the success of the biometric authentication and then performs processing. Note that the biometric authentication is not limited to authentication using the bioelectrical impedance method, but may be authentication using a pulse or vein authentication verifying the user by scanning the pattern of the blood vessels.

Both the inter-device authentication and the biometric authentication are performed automatically when the user 11 puts the electronic bracelet 10 on. The electronic bracelet 10 then determines, when both the inter-device authentication and the biometric authentication have succeeded, that the user currently wearing the electronic bracelet 10 is the owner of the electronic bracelet 10, and automatically enables a predetermined function such as the described-above function. That is, the electronic bracelet 10 releases a security lock to execute a predetermined function such as the above-described function in cooperation with the smartphone 20.

Thus, in the present embodiment, the user authentication processing is automatically executed to determine whether or not the user currently wearing the electronic bracelet 10 is the owner of the electronic bracelet 10 by using the following two features: (1) the electronic bracelet 10 is used together with a wireless device which the user carries with him/her at all times, namely, the smartphone 20, and (2) the electronic bracelet 10 is a wearable device which can be put on the human body. Therefore, the user 11 can use a predetermined function of the electronic bracelet 10 simply by putting the electronic bracelet 10 on the body in such a state where the smartphone 20 is carried with or is in the vicinity to the user 11. Further, once initial settings, that is, the setting of the pairing and the registration of biological data for the biometric authentication (including a subsequent calibration operation of the biometric authentication data and the like) have been done, the two-stage authentication (inter-device authentication and biometric authentication) can be automatically performed by such a simple action of the user 11 as to put the electronic bracelet 10 on the wrist. Therefore, it becomes possible to easily carry out higher level of security measures.

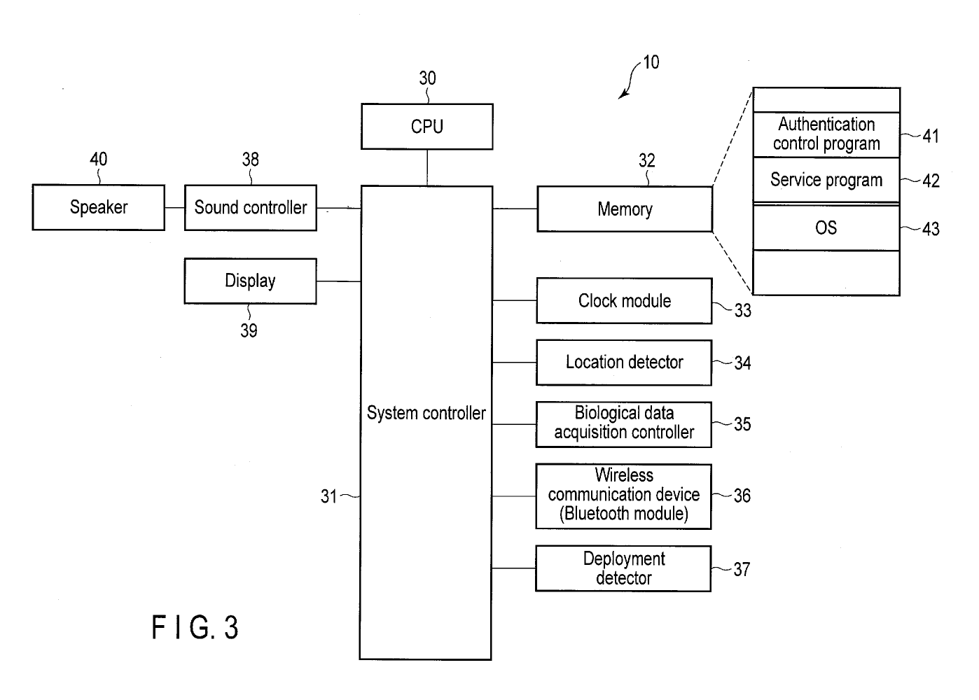

Next, with reference to FIG. 3, the system structure of the electronic bracelet 10 will be described.

The electronic bracelet 10 comprises a CPU 30, a system controller 31, a memory 32, a clock module 33, a location detector 34, a biological data acquisition controller 35, a wireless communication device (Bluetooth [registered trademark] module) 36, a deployment detector 37, a sound controller 38, a display 39, a speaker 40, and the like.

The CPU 30 is a processor configured to control the operation of various components of the electronic bracelet 10. The CPU 30 includes circuitry (processing circuitry). The CPU 30 executes an operating system (OS) 43 loaded in the memory 32 and various application programs loaded in the memory 32. The application programs include an authentication control program 41 and a service program 42.

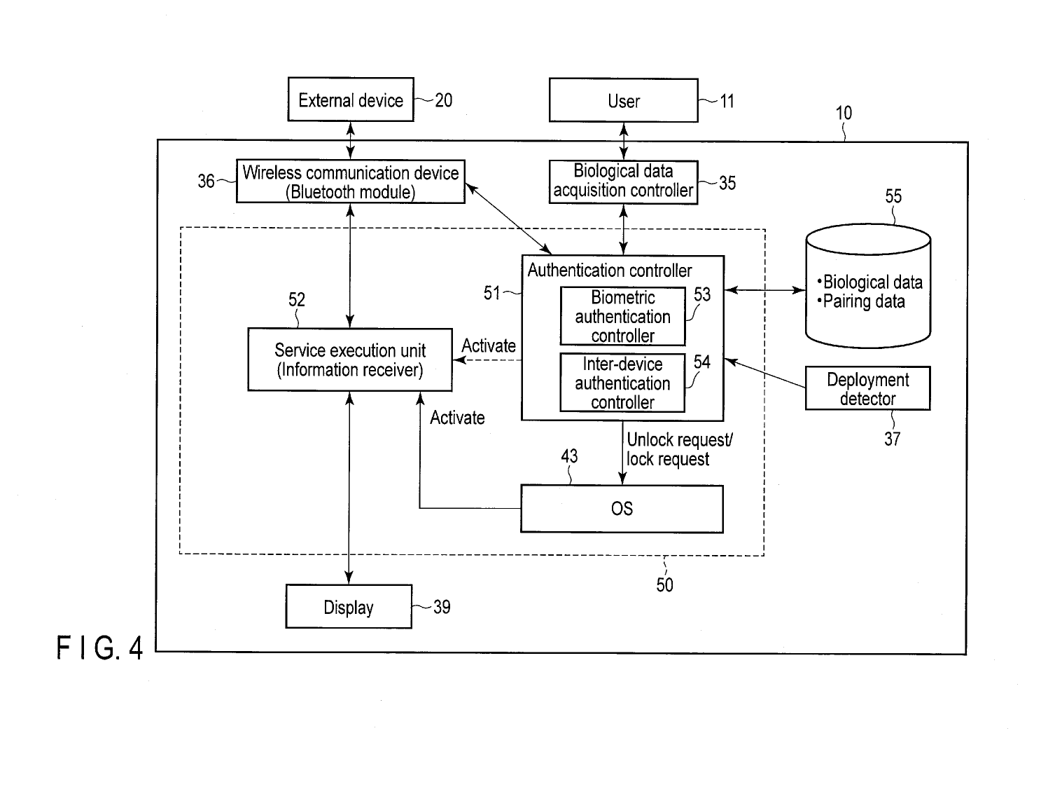

The authentication control program 41 is a program for performing the above-described inter-device authentication and biometric authentication. The service program 42 is a program for executing the above-described predetermined function. Note that the authentication control program 41, the service program 42 and the OS 43, which will be described later with reference to FIG. 4, are executed in cooperation with each other.

The system controller 31 is a bridge device configured to connect the CPU 30 and each component to each other. The system controller 31 comprises a built-in memory controller configured to perform access control of the memory 32. Further, the system controller 31 may also comprise a built-in display controller configured to control the display 39 of the electronic bracelet 10. Still further, the system controller 31 comprises a function of executing communication with the sound controller 38.

The sound controller 38 is a sound source device and is configured to output audio data to be reproduced to the speaker 40. The wireless communication device (Bluetooth module) 36 is configured to execute wireless communication by means of, for example, Bluetooth.

The clock module 33 is a module configured to clock a current time. The location detector 34 is configured to acquire the current location of the electronic bracelet 10, for example, the longitude and the latitude indicating the current location of the electronic bracelet 10. The location detector 34 corresponds to, for example, the global positioning system (GPS).

The biological data acquisition controller 35 comprises one or more sensors configured to measure biological data of the user 11. The deployment detector 37 is configured to detect that the electronic bracelet 10 is put on the user (human body) 11, and that the electronic bracelet 10 is removed from the user (human body) 11. More specifically, the deployment detector 37 detects closing of the buckle or the like of the electronic bracelet 10 as putting of the electronic bracelet 10 on the user (human body) 11, and detects opening of the buckle or the like as removing of the electronic bracelet 10 from the user (human body) 11.

Next, with reference to FIG. 4, the structure of software executed by the electronic bracelet 10 will be described.

Software 50 consists of the above-described authentication control program 41, service program 42, and OS 43. The authentication control program 41 comprises an authentication controller 51, and the service program 42 comprises a service execution unit 52. Further, the authentication controller 51 comprises a biometric authentication controller 53 and an inter-device authentication controller 54.

The biometric authentication controller 53 starts biometric authentication when the deployment detector 37 detects that the electronic bracelet 10 has been put on. The biometric authentication controller 53 measures the biological data of the user 11 by using the biological data acquisition controller 35 (sensor). Further, the biometric authentication controller 53 compares the biological data of the user 11 measured by the biological data acquisition controller 35 (sensor) with biological data stored in a storage 55 (registered biological data) and determines whether or not the measured biological data corresponds to the registered biological data, that is, whether or not the features of the measured biological data match (correspond to/coincide with) the features of the registered biological data.

Further, the inter-device authentication controller 54 starts inter-device authentication when the deployment detector 37 detects that the electronic bracelet 10 has been put on. In the inter-device authentication, the inter-device authentication controller 54 performs connection control processing via the wireless communication controller 36 to establish wireless connection between the electronic bracelet 10 and an external device (i.e, smartphone 20). In the connection control processing, pairing data stored in the storage 55 is used. The pairing data stored in the storage 55 is authentication data necessary for establishing wireless connection between the electronic bracelet 10 and a wireless device associated with the electronic bracelet 10 in advance. The inter-device authentication controller 54 performs inter-device authentication using communication between the electronic bracelet 10 and the external device (i.e, smartphone 20). The inter-device authentication controller 54 determines, when the inter-device authentication has succeeded, that the external device (i.e, smartphone 20) is a wireless device associated with the electronic bracelet 10 in advance (the inter-device authentication has succeeded). Subsequently, wireless connection is established between the electronic bracelet 10 and the smartphone 20.

When the biometric authentication succeeds and the inter-device authentication succeeds as well, that is, when the two-stage authentication succeeds, the authentication controller 51 may transmit an unlock request to the OS 43. The unlock request is a request to release the security lock of the electronic bracelet 10 to change the above-described predetermined function from a disabled state to an enabled state. In response to the unlock request, the OS 43 may release the security lock of the electronic bracelet 10 to instruct the service execution unit (data receiver) 52 to activate a predetermined function. Note that, when the two-stage authentication has succeeded, the authentication controller 51 may instruct the service execution unit 52 to activate a predetermined function without transmitting the unlock request to the OS 43. When either one authentication of the two-stage authentication has not succeeded, the authentication controller 51 will not transmit the unlock request to the OS 43.

When receiving an instruction from the OS 43 or the authentication controller 51 to activate a predetermined function, the service execution unit 52 displays the above-described schedule information 12, weather information 13, location information 14, traffic information 15, or the like on the display 39 in cooperation with the smartphone 20.

Note that, when the deployment detector 37 detects that the electronic bracelet 10 is removed from the human body, the authentication controller 51 transmits the unlock request to the OS 43. In this way, the predetermined function executed by the service execution unit 52 is disabled (locked). Further, in a case where, for example, established wireless connection between the electronic bracelet 10 and the smartphone 20 is released (disconnected) for some reason after the two-stage authentication has succeeded, that is, after the predetermined function has started, the authentication controller 51 may disable the predetermined function. In that case, the authentication controller 51 may transmit the unlock request to the OS 43.

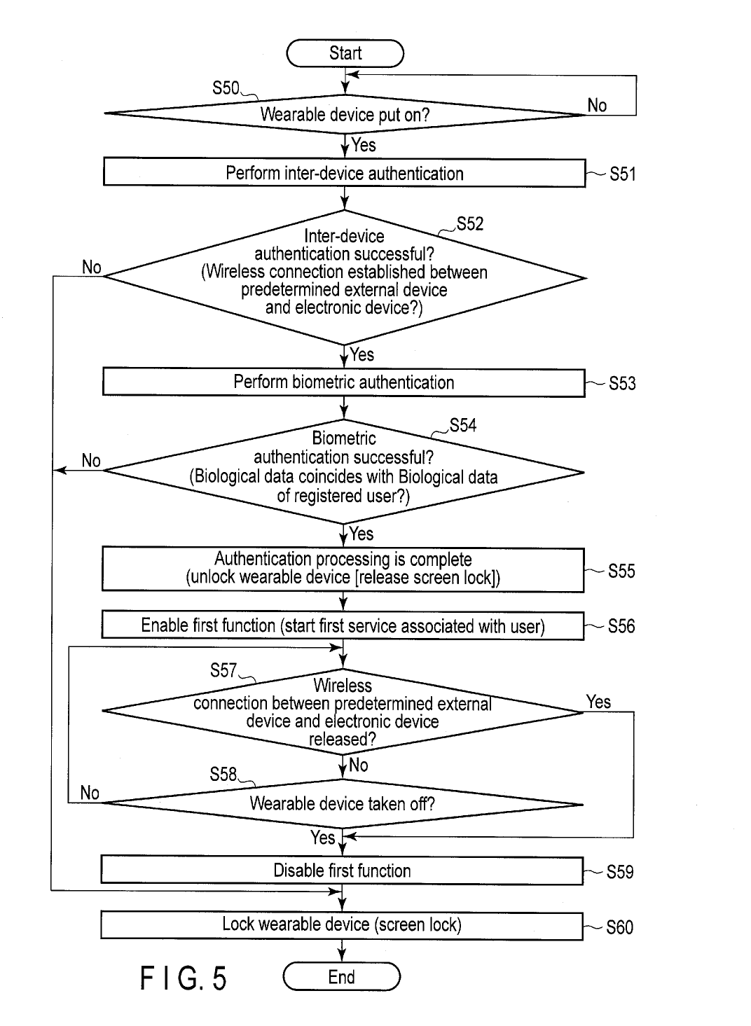

With reference to FIG. 5, the procedure of the user authentication processing executed by the electronic bracelet 10 will now be described.

Firstly, the authentication controller 51 determines whether or not the electronic bracelet (wearable device) 10 has been put on the human body. If the electronic bracelet 10 has been put on the human body, that is, if the deployment detector 37 detects the electronic bracelet 10 has been put on (YES in step S50), the authentication controller 51 performs the inter-device authentication (step S51). If the electronic bracelet 10 has not been put on the human body (NO in step S50), the authentication controller 51 stands by until the electronic bracelet 10 is put on the human body.

After the inter-device authentication has been performed in the step S51, the authentication controller 51 determines whether the inter-device authentication has succeeded or not based on the pairing data registered in advance (step S52). That is, the authentication controller 51 determines by using the above-described pairing data whether or not wireless connection has been established between the electronic bracelet 10 and the smartphone 20 associated with the electronic bracelet 10 in advance (step S52). If the inter-device authentication has not succeeded (NO in step S52), the authentication controller 51 proceeds to the step S60 and maintains the electronic bracelet 10 to be in a security lock state (step S60). Note that the lock operation in the step S60 corresponds to the lock operation described above with referent to FIG. 4, but this lock operation may include a lock operation of the screen of the electronic bracelet 10 or the like. The lock operation of the screen is, for example, to prevent information other than specific information such as a clock or the like from being displayed on the display 39.

If the inter-device authentication has succeeded (YES in step S52), the authentication controller 51 executes the biometric authentication (step S53). If the biometric authentication has failed (NO in step S54), the authentication controller 51 maintains the electronic bracelet 10 to be in the security lock state (step S60).

On the other hand, if the biometric authentication has succeeded, that is, if the biological data of the user 11 measured by the biometric authentication coincides with biological data registered in advance (YES in step S54), the authentication controller 51 determines that the two-stage authentication processing has been complete, and then unlocks the electronic bracelet 10 (step S55). The authentication controller 51 or the OS 43 then enables a predetermined function (first function) associated with the user 11 to start the first function (step S56). More specifically, the service execution unit 52 is activated, and the service execution unit 52 starts service (above-described predetermined function) of displaying the data related to the user 11 on the display 39 in cooperation with the smartphone 20. In that case, the service execution unit 52 may transmit an identifier of the electronic bracelet 10 to the smartphone 20 in order to acquire the data related to the user 11 from the smartphone 20. The smartphone 20 receives the identifier of the electronic bracelet 10 and based on the identifier of the electronic bracelet 10, determines the data to be provided to the user 11 of the electronic bracelet 10.

If the wireless connection between the smartphone 20 and the electronic bracelet 10 is released (disconnected) after the above-described function has started (YES in step S57) or if the electronic bracelet (wearable device) 10 is removed from the human body after the above-described function has started (YES in step S58), the authentication controller 51 disables the first function (step S58). Then, the authentication controller 51 transmits a lock request to the OS 43 to lock the electronic bracelet 10 (step S60).

Note that the above-provided descriptions are made in connection with such a case where the inter-device authentication is executed first and the biometric authentication is then executed, but the embodiment is not limited to the above case and it is also possible to perform the biometric authentication of the step S53 before performing the inter-device authentication of the step S51. That is, it is also possible to switch between the processing of the step S51 and the succeeding step S52 and the processing of the step 53 and the succeeding step 54.

Further, when the buckle or the like is closed even in such a state where the electronic bracelet 10 is not put on the wrist of the user 11, the processing of the step 51 and the subsequent steps is executed as well. However, if the electronic bracelet 10 is not put on the wrist of the user 11, the biological data acquisition controller 35 cannot acquire biological data. Therefore, in the step S54, the biometric authentication is determined to have been failed. Subsequently, in the step S60, the electronic bracelet 10 remains locked. Consequently, the electronic bracelet 10 will not be unlocked in a state where the electronic bracelet 10 is not put on the user 11 (human body).

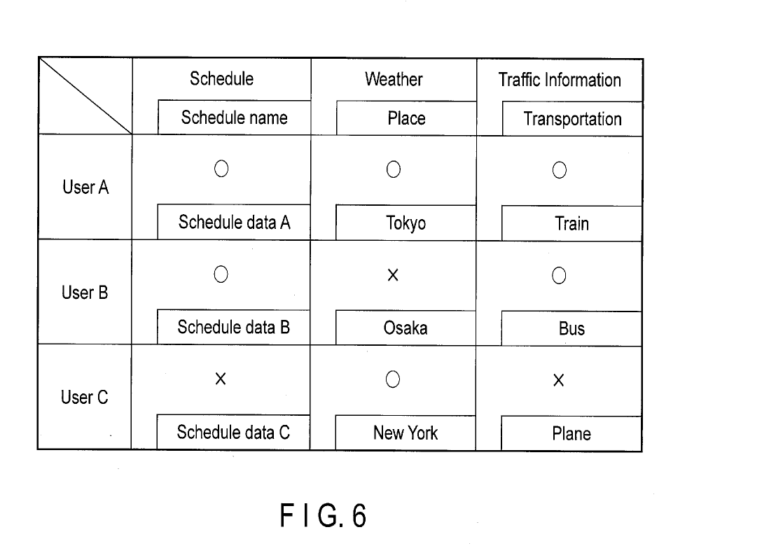

Next, with reference to FIG. 6, an example of the database stored in a wireless device will now be described.

The wireless device may be the above-described smartphone or may be a tablet computer. When the wireless device is a tablet computer, there is a case where the wireless device is shared with a plurality of users such as the family members of the owner of the wireless device. In that case, it is preferable that the wireless device be configured to provide different services to the respective plurality of wearable devices (plurality of users) registered in the wireless device. The database of FIG. 6 can provide services to three electronic bracelets of three users, namely, user A, user B and user C, respectively.

In the database of FIG. 6, the category of a function (information) to be provided and the setting information of each function are stored for each user name (electronic bracelet name). Each user can set a function the user wants to use to a wireless device. Here, user A has a setting to use three functions of the schedule function, the weather function and the traffic information function. User B has a setting to use two functions of the schedule function and the traffic information function. User C has a setting to use the weather function. Further, in the database, a schedule data name for identifying the schedule data corresponding to user A, place identification data indicating a local (regional) weather information to be provided to user A, and transportation identification data indicating necessary traffic information or the like of transportation to be provided to user A are defined. Similarly, a schedule data name for identifying the schedule data corresponding to user B, transportation identification data indicating necessary traffic information of transportation to be provided to user B, and place identification data indicating a local (regional) whether information to be provided to user C are defined.

The electronic bracelet of user A transmits, for example, device ID data of the electronic bracelet 10 to a wireless device in order to identify the user when the above-described two-stage authentication has succeeded. The wireless device determines service (information) to be provided to the electronic bracelet of user A based on the database of FIG. 6, and transmits the determined information to the electronic bracelet of user A.

As described above, according to the first embodiment, it is possible to perform biometric authentication of the user 11 wearing the wearable electronic bracelet 10 and inter-device authentication between the electronic bracelet 10 and an external device (smartphone 20). If the biometric authentication and the inter-device authentication have succeeded, a predetermined (first) function can be enabled. Therefore, the user 11 can easily use the electronic bracelet 10. Further, it is possible to carry out a two-stage security measure by a simple action of the user 11 to put the electronic bracelet 10 on the wrist. Still further, since an unlock operation is automatically performed to enable the predetermined function, there is no need for the user 11 to enter a PIN or a pattern. Still further, the electronic bracelet 10 can provide a predetermined function corresponding to each of a plurality of users.

### Second Embodiment

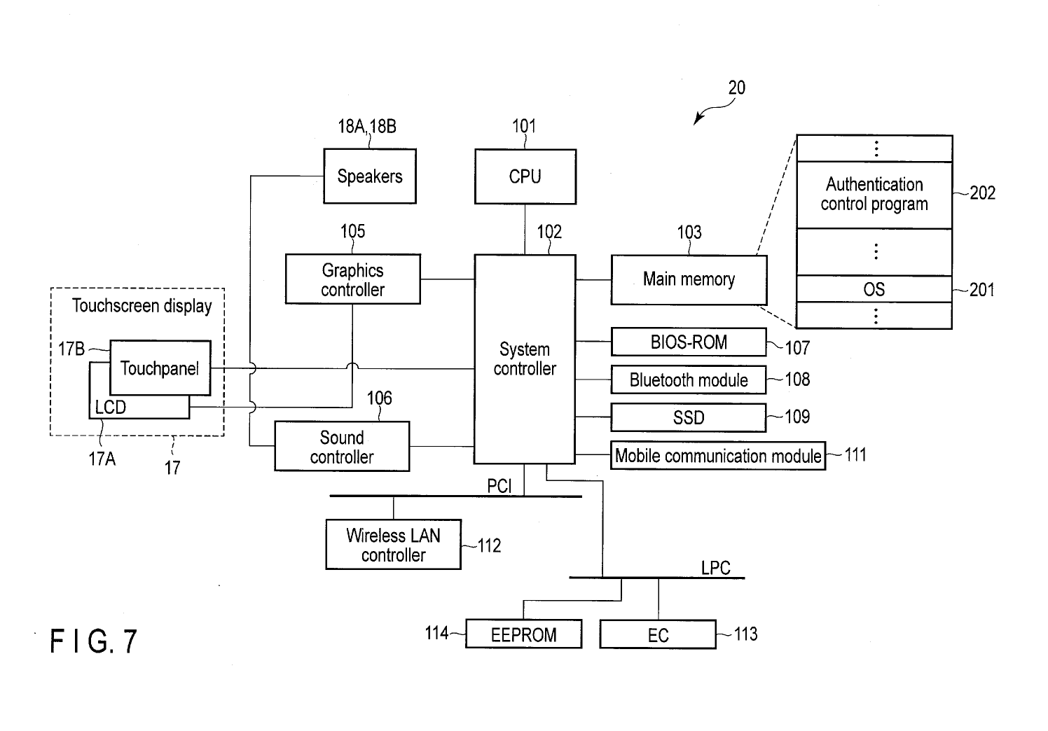

The second embodiment will now be described with reference to FIGS. 7 to 9. Note that descriptions of the structures and operations similar to those of the first embodiment will be omitted.

In the first embodiment, when the two-stage authentication has succeeded, a predetermined function of the electronic bracelet 10 is enabled. On the other hand, in the second embodiment, the lock (security lock) of the smartphone 20 is released when the two-stage authentication has succeeded.

FIG. 7 is a block diagram showing an example of the system structure of the smartphone 20.

The smartphone 20 comprises a CPU 101, a system controller 102, a main memory 103, a graphics controller 105, a sound controller 106, a BIOS-ROM 107, a Bluetooth (registered trademark) module 108, a solid-state drive (SSD) 109, a mobile communication module 111, a wireless LAN controller 112, an embedded controller (EC) 113, an EEPROM 114, a touchscreen display 17 and the like.

The CPU 101 is a processor configured to control the operation of various components of the smartphone 20. The CPU 101 executes an operating system (OS) 201 and various application programs, the OS 201 and the application programs being loaded from the storage (SSD) 109 to the main memory 103. The application programs include an authentication control program 202.

The authentication control program 202 comprises a function similar to the authentication control program 41 in the electronic bracelet 10 of the first embodiment, but further comprises a function of releasing the lock of the smartphone 20 when the two-stage authentication succeeds.

Further, the CPU 101 executes a basic input/output system (BIOS) stored in the BIOS-ROM 107. The BIOS is a program for performing hardware control.

The system controller 102 is a bridge device configured to connect the CPU 101 and each component to each other. The system controller 102 comprises a built-in memory controller configured to perform access control of the memory 103. Further, the system controller 102 may comprise a built-in display controller configured to control a touchscreen display 17. Still further, the system controller 102 comprises a function of executing communication with the sound controller 106. The system controller 102 also comprises a function of executing communication with the graphics controller 105, for example, via a serial bus conforming to the PCI EXPRESS standard.

The graphics controller 105 is a display controller configured to control an LCD 17A used as a display monitor of the smartphone 20. The image signal (also called a display signal) generated by the graphics controller 105 is transmitted to the LCD 17A.

Further, the system controller 102 controls each device on a Peripheral Component Interconnect (PCI) bus and each device on a Low Pin Count (LPC) bus. Still further, a south bridge 104 comprises a built-in Integrated Drive Electronics (IDE) controller for performing control of the SSD 109.

The sound controller 106 is a sound source device and is configured to output audio data to be reproduced to speakers 18A and 18B. A wireless LAN controller 112 is a wireless communication device configured to execute, for example, wireless communication conforming to the IEEE 802.11 standard.

The EC 113 is an embedded controller for performing power management. The EC 113 comprises a function of powering the smartphone 20 on/off based on the user's operation.

In the touchpanel display 17, a touchpanel 17B in addition to the LCD 17A is incorporated. The touchpanel 17B to be overlaid on the LCD 17A comprises a sensor, a micro controller unit (MCU) and the like. When a touch operation is performed on the touchpanel 17B, the touched position is detected by the sensor, and input data including the touched position on the touch panel 17B is output by the MCU.

The mobile communication module 111 is configured to perform wireless communication using a mobile phone communication network such as wireless communication conforming to the 3G or LTE communication standard.

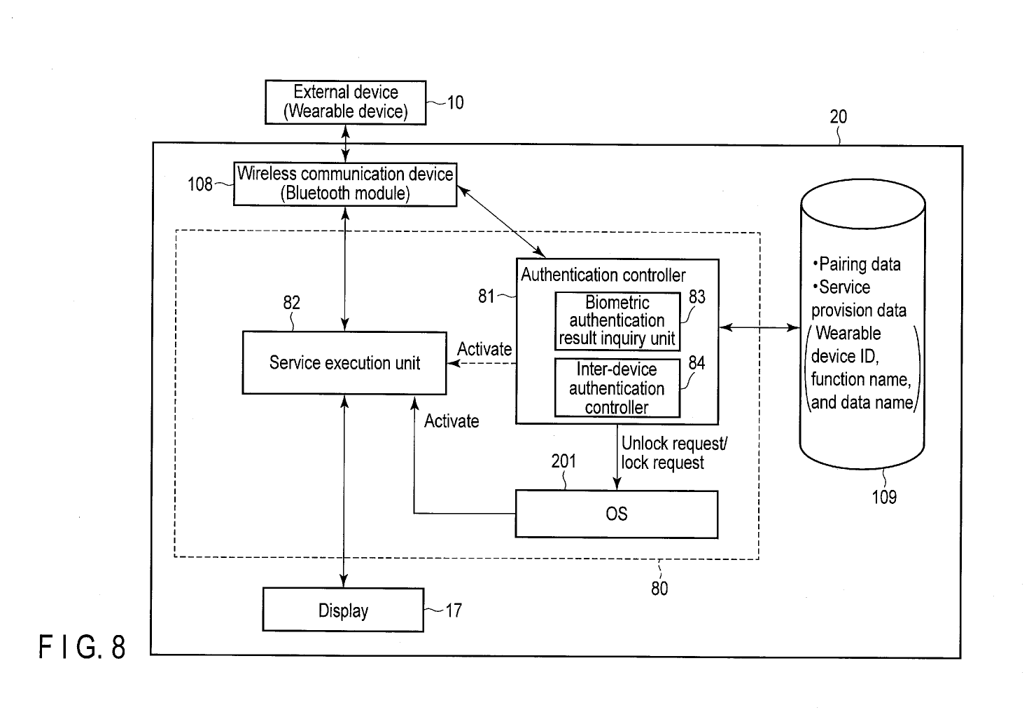

Next, with reference to FIG. 8, the system structure of each application program will be described.

An application program 80 comprises an authentication controller 81, a service execution unit 82 and the like. The authentication controller 81 comprises a biometric authentication result inquiry unit 83 and an inter-device authentication controller 84. The authentication controller 81 can perform wireless communication with an external device, namely, the electronic bracelet 10. In the storage 109, the pairing data and service provision data are stored. The service provision data includes, for example, the ID of the electronic bracelet 10, the name of a predetermined function, data of the predetermined function, or the like.

The inter-device authentication controller 84 is configured to perform the processing of the inter-device authentication to determine whether or not wireless connection has been established between the smartphone 20 and the electronic bracelet 10 associated with the smartphone 20. In the inter-device authentication, the inter-device authentication controller 84 performs the connection control processing to establish wireless connection between the smartphone 20 and an external device. In the connection control processing, the pairing data stored in the storage 109 is used. The pairing data stored in the storage 109 is authentication data necessary for establishing wireless connection between an external device (wearable device) associated with the smartphone 20 in advance and the smartphone 20. The inter-device authentication is performed by means of communication between the smartphone 20 and the external device. The inter-device authentication controller 84 determines, when the inter-device authentication has succeeded, that the external device is a wearable device associated with the electronic bracelet 10 in advance (the inter-device authentication has succeeded). Wireless connection is then established between the electronic bracelet 10 and the smartphone 20.

The biometric authentication result inquiry unit 83 is configured to inquire of the electronic bracelet 10 associated with the smartphone 20 as to whether or not the biometric authentication of the user 11 has succeeded in the electronic bracelet 10. The service execution unit 82 enables a predetermined function in response to an instruction from the OS 201 or the authentication controller 81 when the two-stage authentication has succeeded. Note that, when the two-stage authentication has succeeded, the service execution unit 82 performs an release (unlock) operation of a lock of the smartphone 20, which is necessary for enabling a predetermined function, but may not provide data of the predetermined function to the electronic bracelet 10. Further, the data of the predetermined function may be displayed on the touchscreen display 17 provided in the smarpthone 20.

Further, the service provision data stored in the storage 109 includes data used to identify the electronic bracelet 10. The service execution unit 82 refers to the service provision data, and transmits to the electronic bracelet 10 the data of a predetermined function corresponding to the electronic bracelet 10 in which the two-stage authentication has successfully performed by the authentication controller 81.

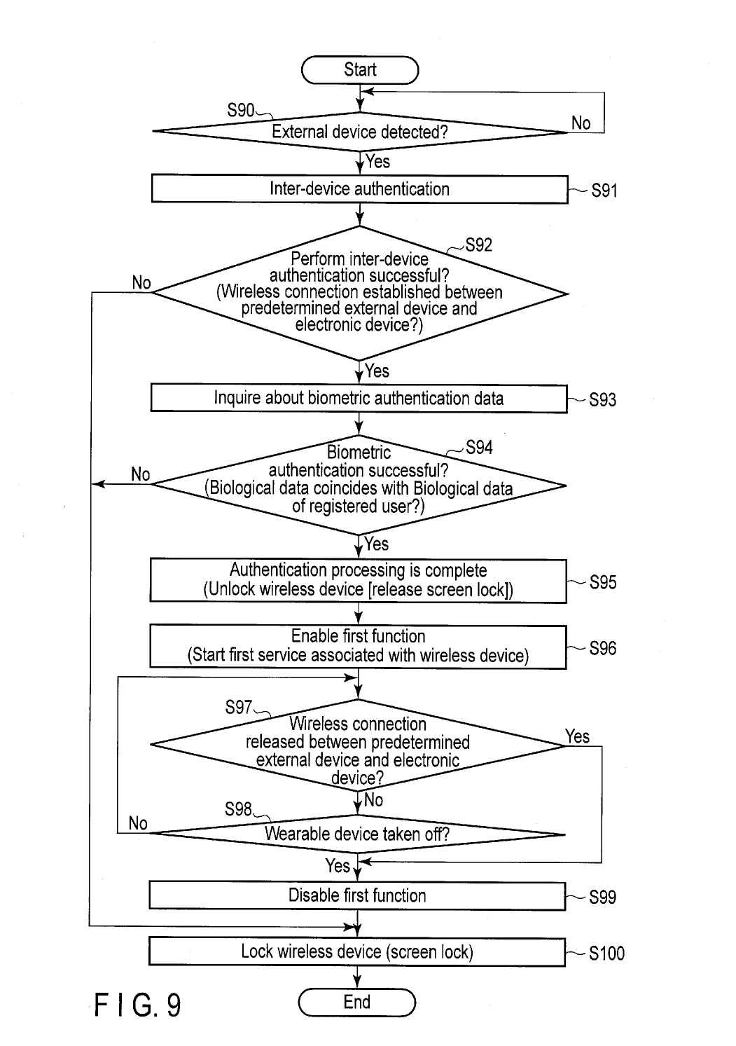

Next, with reference to FIG. 9, the procedure of the authentication processing executed by the smartphone 20 will be described.

Firstly, the authentication controller 81 determines whether a wearable external device which can be put on the human body, namely, the electronic bracelet 10 has been detected or not (step S90). When the electronic bracelet 10 has been detected, that is, when the electronic bracelet 10 wirelessly connectable by the wireless communication device (Bluetooth module) 108 has been detected (YES in step S90), the authentication controller 81 performs the above-described inter-device authentication (step S91). When the electronic bracelet 10 has not been detected (NO in step S90), the authentication controller 81 stands by until the electronic bracelet 10 is detected.

After the inter-device authentication is performed in the step S91, the authentication controller 81 determines whether the inter-device authentication has succeeded or not based on the pairing data registered in advance (step S92). That is, the authentication controller 81 determines by using the above-described pairing data whether or not wireless connection has been established between the smartphone 20 and the electronic bracelet 10 associated with the smartphone 20 in advance (step S92). When the inter-device authentication has not succeeded (NO in step S92), the authentication controller 81 proceeds to the step S100 and maintains the smartphone 20 to be in a lock state (step S100).

When the inter-device authentication has succeeded (YES in step S92), the authentication controller 81 inquires of the electronic bracelet 10 as to whether or not the above-described biometric authentication executed by the electronic bracelet 10 has succeeded (step S93). When receiving information indicating that the biometric authentication has failed from the electronic bracelet 10, the authentication controller 81 determines that the biometric authentication has failed (NO in the step S94). In that case, the authentication controller 81 maintains the smartphone 20 to be in a lock state (step S100).

On the other hand, when receiving information indicating that the biometric authentication has succeeded from the electronic bracelet 10, the authentication controller 81 determines that the biometric authentication has succeeded (YES in step S94). The authentication controller 81 then determines that the two-stage authentication processing has been complete, and unlocks the smartphone 20 (step S95). In other words, the lock (screen lock) of the smartphone 20 is released. Subsequently, the authentication controller 81 or the OS 201 enables the first function associated with the electronic bracelet 10 to start the first function (step S96). Note that it is also possible to perform only an unlock operation of the smartphone 20 to enable the first function of the smartphone 20.

When wireless connection between the smartphone 20 and the electronic bracelet 10 is released after the above-described first function has been started (YES in step S97) or when a notification is received from the electronic bracelet 10 that the electronic bracelet (wearable device) 10 is removed from the human body after the above-described first function has been started, the authentication controller 81 disables the first function (step S99). Subsequently, the authentication controller 81 transmits a lock request to the OS 201 to lock the smartphone 20 (step S100).

As described above, in the second embodiment, it is possible to perform inter-device authentication with respect to the electronic bracelet configured to perform the biometric authentication of the user 11 in order to establish wireless connection therewith. Further, the electronic bracelet 10 is inquired of as to whether the biometric authentication has succeeded or not. When the inter-device authentication and the biometric authentication have succeeded, it is possible to release the lock to enable a predetermined function of the smartphone 20. Further, for example, when the two-stage authentication has succeeded in a state where the user 11 is wearing the electronic bracelet 10, the lock of the smartphone 20 is automatically released. Therefore, the user can use the smartphone 20 without performing an operation on the smartphone 20 to release the lock of the smartphone 20. Still further, since the lock of the smartphone 20 has been automatically released, the user 11 will know that the user 11 is wearing the electronic bracelet 10 on the wrist.

Still further, the functions of the authentication control program 41 described in the first embodiment and of the authentication control program 202 described in the second embodiment may be realized by hardware such as a special-purpose LSI, a DSP or a microcomputer.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic device comprising:
a first authentication controller configured to perform biometric authentication to measure biological data of a user and to determine whether or not the biological data corresponds to registered biological data;
a second authentication controller configured to perform inter-device authentication by means of communication between the electronic device and a first external device; and
a controller configured to enable a predetermined function when the biometric authentication and the inter-device authentication succeed.

2. The electronic device of claim 1, wherein the first external device is a device associated with the electronic device.

3. The electronic device of claim 1, wherein the predetermined function comprises a function of displaying data acquired from the first external device.

4. The electronic device of claim 1, further comprising a detector configured to detect that the electronic device is put on a human body, wherein the biometric authentication and the inter-device authentication are executed when the electronic device is put on the human body.

5. The electronic device of claim 1, wherein the controller disables the predetermined function when the electronic device is removed from the human body after the predetermined function is enabled.

6. The electronic device of claim 1, wherein the controller disables the predetermined function when wireless connection between the electronic device and the first external device is released after the predetermined function is enabled.

7. The electronic device of claim 1, wherein the predetermined function comprises a function of displaying data acquired from the first external device, and the controller transmits identification data of the electronic device to the first external device to acquire the data.

8. A method of performing an authentication by an electronic device, comprising:
performing biometric authentication to measure biological data of a user and to determine whether or note the biological data corresponds to registered biological data;
performing inter-device authentication by means of communication between the electronic device and a first external device; and
enabling a predetermined function when the biometric authentication and the inter-device authentication succeed.

9. An electronic device comprising:
an authentication controller configured to perform inter-device authentication by means of communication between the electronic device and a first external device;
an inquiry controller configured to inquire of the first external device as to whether or not biometric authentication succeeds, the biometric authentication to measure biological data of a user and to determines whether or not the biological data corresponds to registered biological data; and
a controller configured to release a lock of the electronic device to enable a predetermined function of the electronic device when the inter-device authentication and the biometric authentication succeed.

10. A method of performing an authentication by an electronic device, comprising:
performing inter-device authentication by means of communication between a first external device and the electronic device;
inquiring of the first external device as to whether or not biometric authentication succeeds, the biometric authentication to measure biological data of a user and to determines whether or not the biological data corresponds to registered biological data; and
releasing a lock of the electronic device to enable a predetermined function of the electronic device when the inter-device authentication and the biometric authentication succeed.
